(19) United States
(12) Patent Application Publication
(10) Pub. No.: US 2012/0183123 A1
(43) Pub. Date: Jul. 19, 2012

(54) RADIATION IMAGING SYSTEM AND CONTROL METHOD THEREOF

(75) Inventor: Takuji TADA, Ashigarakami-gun (JP)

(73) Assignee: FUJIFILM CORPORATION, Tokyo (JP)

(21) Appl. No.: 13/341,466

(22) Filed: Dec. 30, 2011

(30) Foreign Application Priority Data
Jan. 14, 2011 (JP) 2011-006011

(51) Int. Cl. G01N 23/04

(52) U.S. Cl. 378/62

(57) ABSTRACT

A moiré fringe difference detector detects a change in moiré fringes occurring in first and second differential phase images between actual radiography and preliminary radiography, and calculates a characteristic amount corresponding to the change. This characteristic amount is a period of an artifact occurring in a corrected differential phase image, which is obtained by subtracting the second differential phase image captured in the preliminary radiography from the first differential phase image captured in the actual radiography. A system controller compares this period with a view size of an X-ray image detector. When the period is smaller than the view size, a message to suggest re-execution of the preliminary radiography is displayed on a monitor. When the preliminary radiography is re-executed, a new second differential phase image obtained by the re-execution of the preliminary radiography is subtracted from the first differential phase image, to produce a new corrected differential phase image.

### BACKGROUND OF THE INVENTION

1. Field of the Invention

The present invention relates to a radiation imaging system, which takes a radiographic image using radiation such as X-rays.

The present invention especially relates to the radiation imaging system for carrying out phase imaging and a control method of the system.

2. Description Related to the Prior Art

X-rays are used as a probe for imaging the inside of an object without incision, due to the characteristic that attenuation of the X-rays depends on the atomic number of an element constituting the object and the density and thickness of the object. Radiography using the X-rays is widely available in fields of medical diagnosis, nondestructive inspection, and the like.

In a conventional X-ray imaging system for capturing a radiographic image of the object, the object to be examined is disposed between an X-ray source for emitting the X-rays and an X-ray image detector for detecting the X-rays. Each X-ray emitted from the X-ray source is attenuated (absorbed) by an amount depending on the characteristics (atomic number, density, and thickness) of a material existing in its path, and is then incident upon a pixel of the X-ray image detector. Thus, the X-ray image detector detects and forms an X-ray absorption contrast image of the object. As the X-ray image detector, a flat panel detector (FPD) having semiconductor circuitry is widely used, in addition to a combination of an X-ray intensifying screen and a film, and an imaging plate containing photostimulable storage phosphors.

The smaller the atomic number of the element constituting the material, the smaller X-ray absorption coefficient the material has. Thus, the X-ray absorption contrast image of in vivo soft tissue, soft material, or the like cannot have sufficient image contrast. Taking a case of an arthrosis of a human body as an example, both of articular cartilage and its surrounding synovial fluid have water as a predominant ingredient, and little difference in the X-ray absorptivity therebetween. Thus, the X-ray absorption contrast image of the arthrosis cannot have sufficient contrast.

With this problem as a backdrop, X-ray phase imaging is actively researched in recent years. In the X-ray phase imaging, an image (hereinafter called phase contrast image) is obtained based on phase shift of the an X-ray wave front caused by the difference of refraction index of the object, instead of intensity change of the X-rays by the object. When the X-rays are incident on the object, the phase of the X-ray wave front is more susceptible than the intensity of the X-rays. Accordingly, the X-ray phase contrast imaging, which takes advantage of phase difference, allows obtainment of the high contrast image, even if the object has low X-ray absorptivity.

There is proposed a radiation imaging system that adopts the X-ray phase contrast imaging (refer to U.S. Pat. No. 7,180,979 corresponding to Japanese Patent No. 4445397 and Applied Physics Letters Vol. 81, No. 17, page 3287, written by C. David et al. on October 2002, for example). In this system, first and second grids are disposed in parallel at a predetermined distance away from each other. By the Talbot effect of the first grid, a self image of the first grid is formed in the position of the second grid. The second grid applies intensity modulation to the self image, in order to obtain the phase contrast image. Phase information of the object is reflected in a fringe image, which is obtained by the intensity modulation of the self image.

There are various methods for obtaining the phase information of the object from the fringe image, such as a fringe scanning method, a moiré interferometric method, and a Fourier transform method. The U.S. Pat. No. 7,180,979 uses the fringe scanning method. In the fringe scanning method, an image is captured at each scan position whenever the second grid is translationally moved (scanned) relative to the first grid in a direction approximately orthogonal to a grid direction by a predetermined amount smaller than a grid pitch, so a plurality of fringe images are obtained. From the plural fringe images, a differential phase value corresponding to an amount of the phase shift of the X-ray wave front is obtained based on the intensity change of each individual pixel value. Based on a two-dimensional image (differential phase image) of the differential phase values, the phase contrast image is produced. The fringe scanning method is available in an imaging system using laser light, instead of the X-rays (refer to Applied Optics Vol. 37, No. 26, page 6227 written by Hector Canabal et al. on September 1998, for example).

In the fringe scanning method, if manufacturing error, distortion, misalignment or the like occurs in the first or second grid, a value irrelevant to the object is added to the differential phase value of each pixel. To solve this problem, the U.S. Pat. No. 7,180,979 discloses to perform “actual radiography” in which a sequence of radiographic operation is carried out in the presence of the object between the X-ray source and the X-ray image detector, and “preliminary radiography” in which the sequence of radiographic operation is carried out in the absence of the object. By subtracting a second differential phase image obtained in the preliminary radiography from a first differential phase image obtained in the actual radiography, the differential phase image ascribable to the object itself is produced.

It is not necessary to carry out the preliminary radiography whenever the actual radiography is performed. The preliminary radiography may be carried out at a time of starting up the radiation imaging system, and the obtained second differential phase image may be stored on a memory as correction data.

However, moiré fringes occur in each of the first and second differential phase images in accordance with the positions of the first and second grids. Thus, if the positional relation between the first and second grids is changed between the preliminary radiography and the actual radiography, the moiré fringes are changed between the first and second differential phase images. In this case, the moiré fringes cannot be compensated for by the above subtraction processing, and remain as an artifact.

### SUMMARY OF THE INVENTION

An object of the present invention is to provide a radiation imaging system and a control method of the system that can reduce the occurrence of an artifact caused by change in moiré fringes between preliminary radiography and actual radiography.

To solve the above and other objects of the present invention, a radiation imaging system according to the present invention includes a radiation image detector, at least one grid, a differential phase image generating section, a subtraction processing section, a moiré fringe difference detector, and a judging section. The radiation image detector captures radiation emitted from a radiation source and produces image data. The grid is disposed between the radiation source and the radiation image detector. The differential phase image generating section generates a differential phase image based on the image data produced by the radiation image detector. The subtraction processing section subtracts a second differential phase image from a first differential phase image to produce a corrected differential phase image. The first differential phase image is generated by the differential phase image generating section in actual radiography performed in a presence of a sample between the radiation source and the radiation image detector. The second differential phase image is generated by the differential phase image generating section in preliminary radiography performed in an absence of the sample. The moiré fringe difference detector detects a change in moiré fringes occurring in the first and second differential phase images between the actual radiography and the preliminary radiography and calculates a characteristic amount corresponding to the change. The judging section judges based on the characteristic amount whether or not re-execution of the preliminary radiography is required.

The moiré fringe difference detector preferably calculates as the characteristic amount a period of a stripe-patterned artifact occurring in the corrected differential phase image. The judging section may compare the period of the artifact with a view size of the radiation image detector, and judge that the re-execution of the preliminary radiography is required when the period is smaller than the view size. In another case, the judging section may compare a ratio between the period of the artifact and a view size of the radiation image detector with a predetermined threshold value in order to judge whether or not the re-execution of the preliminary radiography is required. When the re-execution of the preliminary radiography is carried out, the subtraction processing section preferably subtracts a new second differential phase image newly produced in the re-execution by the differential phase image generating section from the first differential phase image in order to produce a new corrected differential phase image. The radiation imaging system may further include a notification section for sending out a message to suggest the re-execution of the preliminary radiography, when the judging section judges that the re-execution of the preliminary radiography is required. The radiation imaging system may further include a phase contrast image generating section for generating a phase contrast image from the corrected differential phase image through an integration process.

The grid may refer to first and second grids disposed oppositely to each other between the radiation source and the radiation image detector such that grid directions of the first and second grids coincide. In this case, the radiation imaging system may further include a scan mechanism for varying a position of the second grid relative to a position of the first grid to sequentially set the first and second grids at plural scan positions. The differential phase image generating section may calculate a phase shift amount of an intensity modulation signal, which represents variation of a pixel value composing the image data relative to the scan positions, to generate the differential phase image.

The first grid may be an absorption grid and project the radiation incident from the radiation source to the second grid in a geometrical-optics manner, or may be a phase grid and form a self image in a position of the second grid by causing the Talbot effect in the radiation incident from the radiation source.

A control method of the radiation imaging system according to the present invention includes the steps of detecting a change in moiré fringes occurring in the first and second differential phase images between the actual radiography and the preliminary radiography; calculating a characteristic amount corresponding to the change; and judging based on the characteristic amount whether or not re-execution of the preliminary radiography is required.

According to the present invention, the change in the moiré fringes occurring in the first and second differential phase images between the actual radiography and the preliminary radiography is detected. Whether or not the re-execution of the preliminary radiography is required is judged based on the characteristic amount corresponding to the change. Therefore, it is possible to reduce the occurrence of the artifact due to the change in the moiré fringes between the preliminary radiography and the actual radiography.

### BRIEF DESCRIPTION OF THE DRAWINGS

For more complete understanding of the present invention, and the advantage thereof, reference is now made to the following descriptions taken in conjunction with the accompanying drawings, in which:

FIG. 1 is a block diagram showing the structure of an X-ray imaging system;

FIG. 2 is a schematic view of an X-ray image detector;

FIG. 3 is a schematic side view showing the structure of first and second grids;

FIG. 4 is an explanatory view of a fringe scanning method;

FIG. 5 is a graph showing an example of intensity modulation signals in preliminary radiography and actual radiography;

FIG. 6 is a block diagram of an image processor;

FIG. 7 is a block diagram of a moiré fringe difference detector;

FIG. 8 is a profile of a two-dimensional Fourier spectrum passing through a zero-order peak in a u direction; and

FIG. 9 is an explanatory view of a characteristic amount of an artifact occurring in a corrected differential phase image.

### DESCRIPTION OF THE PREFERRED EMBODIMENTS

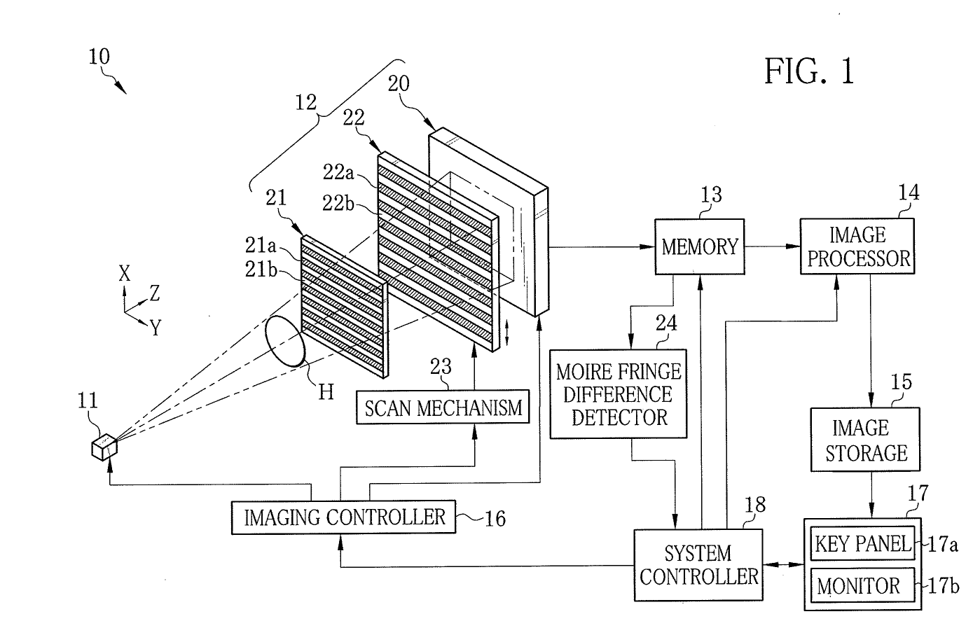

As shown in FIG. 1, an X-ray imaging system 10 is constituted of an X-ray source 11, an imaging unit 12, a memory 13, an image processor 14, image storage 15, an imaging controller 16, a console 17, and a system controller 18. The X-ray source 11 has a rotating anode type of X-ray tube and a collimater for limiting an irradiation field of X-rays, for example, and emits the X-rays to a sample H.

The imaging unit 12 is constituted of an X-ray image detector 20, a first grid 21, and a second grid 22. The first and second grids 21 and 22 being absorption grids are opposed to the X-ray source 11 with respect to a Z direction being an X-ray propagation direction. There is provided a space between the X-ray source 11 and the first grid 21 to dispose the sample H therein. The X-ray image detector 20 is, for example, a flat panel detector (FPD) using semiconductor circuitry. The X-ray image detector 20 is disposed behind the second grid 22 such that its detection surface is orthogonal to the Z direction.

The first grid 21 is provided with a plurality of X-ray absorbing sections 21a and X-ray transparent sections 21b that extend in a Y direction being one direction in a plane orthogonal to the Z direction. The X-ray absorbing sections 21a and the X-ray transparent sections 21b are alternately arranged in an X direction orthogonal to both the Z and Y directions, so as to form a stripe pattern. Likewise, the second grid 22 is provided with a plurality of X-ray absorbing sections 22a and X-ray transparent sections 22b that extend in the Y direction and are alternately arranged in the X direction. The X-ray absorbing sections 21a and 22a are made of a metal having X-ray absorptivity, such as gold (Au) or platinum (Pt). The X-ray transparent sections 21b and 22b are made of a material having X-ray transparency, such as silicon (Si) or resin.

The memory 13 temporarily stores image data read out of the imaging unit 12. The image processor 14 produces a phase contrast image based on the image data of plural frames stored in the memory 13. The image storage 15 records the phase contrast image produced by the image processor 14. The imaging controller 16 controls the X-ray source 11 and the imaging unit 12.

The console 17 includes a key panel 17a for inputting imaging conditions and execution commands of preliminary radiography and actual radiography, as described later, and a monitor 17b for displaying radiography information and a captured image. The system controller 18 performs centralized control of every part in accordance with a signal inputted from the key panel 17a.

The imaging unit 12 includes a scan mechanism 23, which translationally moves the second grid 22 in the X direction to change the position of the second grid 22 relative to the first grid 21. The scan mechanism 23 is composed of, for example, an actuator such as a piezoelectric element. The scan mechanism 23 is driven by the imaging controller 16 during the performance of fringe scanning. Although details will be described later on, the memory 13 stores the image data that is captured by the X-ray image detector 20 in each scan position during the performance of the fringe scanning.

The imaging unit 12 is provided with a moiré fringe difference detector 24 for detecting change in moiré fringes occurring in the image data between the preliminary radiography and the actual radiography. A detection result of the moiré fringe difference detector 24 is inputted to the system controller (judging section) 18. The system controller 18 judges based on the detection result whether or not the re-execution of the preliminary radiography is required. When the re-execution of the preliminary radiography is required, the system controller 18 displays on the monitor 17b as such.

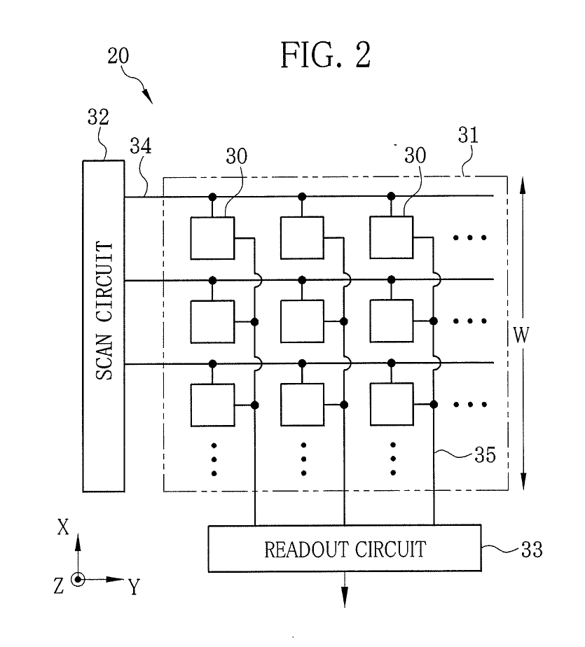

As shown in FIG. 2, the X-ray image detector 20 is constituted of an imaging plane 31, a scan circuit 32, and a readout circuit 33. The imaging plane 31 has a plurality of pixels 30 arranged in two dimensions along the X and Y directions on an active matrix substrate. Each of the pixels 30 converts the X-rays into electric charge and accumulates the electric charge. The scan circuit 32 controls readout timing of the electric charge from the pixels 30. The readout circuit 33 reads out the electric charge from the pixels 30, and converts the electric charge into the image data, and outputs the image data. The scan circuit 32 is connected to every pixel 30 by scan lines 34 on a row-by-row basis. The readout circuit 33 is connected to every pixel 30 by signal lines 35 on a column-by-column basis. The arrangement pitch of the pixels 30 is in the order of 100 μm in each of the X and Y directions.

The pixel 30 is a direct conversion type X-ray detecting element, in which a conversion layer (not shown) made of amorphous selenium or the like directly converts the X-rays into the electric charge, and the converted electric charge is accumulated in a capacitor (not shown) that is connected to an electrode below the conversion layer. Each pixel 30 is provided with a TFT switch (not shown). A gate electrode of the TFT switch is connected to the scan line 34, and a source electrode thereof is connected to the capacitor, and a drain electrode thereof is connected to the signal line 35. Upon turning on the TFT switch by a drive pulse from the scan circuit 32, the electric charge accumulated in the capacitor is read out to the signal line 35.

Each pixel 30 may be an indirect conversion type of X-ray detecting element, in which a scintillator (not shown) made of gadolinium oxide (Gd₂O₃), cesium iodide (CsI), or the like converts the X-rays into visible light, and a photodiode (not shown) converts the visible light into the electric charge. The X-ray image detector 20 is not limited to the TFT panel-based FPD, but another type of radiographic image detector based on a solid-state image sensor such as a CCD or CMOS image sensor may be used instead.

The readout circuit 33 includes an integration amplifier, an A/D converter, a correction section, and the like (none of them is shown). The integration amplifier converts by integration the electric charge outputted from the pixels 30 through the signal lines 35 into an image signal being a voltage signal. The A/D converter converts the image signal produced by the integration amplifier into digital image data. The correction section applies dark current correction, gain correction, linearity correction, and the like to each pixel value composing the image data, and inputs the corrected image data to the memory 13.

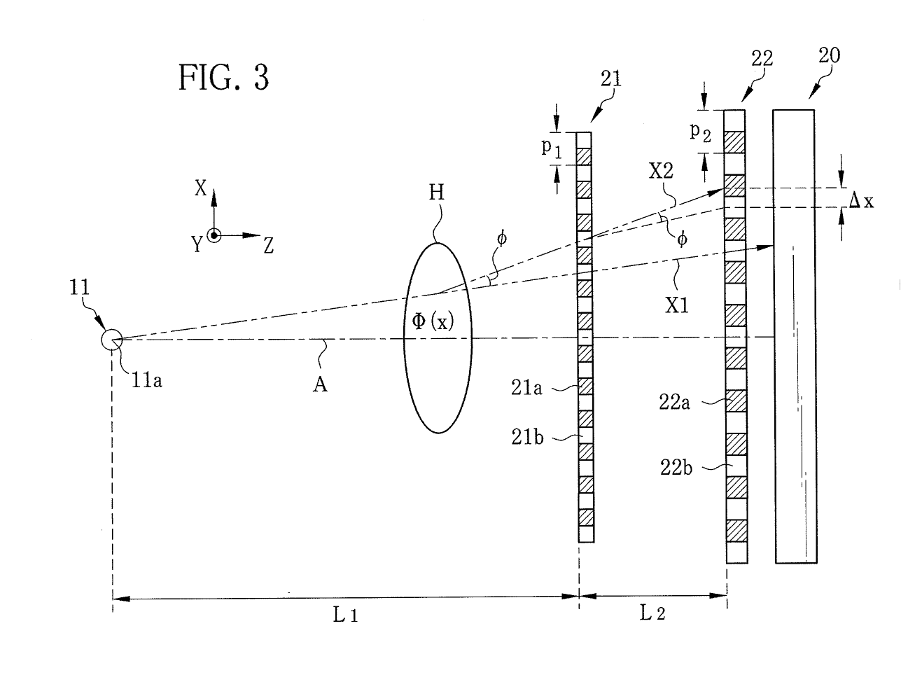

In FIG. 3, the X-rays emitted from the X-ray source 11 are a cone beam divergent from the X-ray focus 11a. Thus, a first periodic pattern image (hereinafter called G1 image) produced by the X-rays having passed through the first grid 21 is magnified in proportion to a distance from the X-ray focus 11a. The arrangement pitch p₂ of the X-ray absorbing sections 22a of the second grid 22 in the X direction are determined by the following expression (1), with use of the length L₁ between the X-ray focus 11a and the first grid 21, the length L₂ between the first and second grids 21 and 22, and the arrangement pitch p₁ of the X-ray absorbing sections 21a of the first grid 21.

$${p}_{2} = \frac{{L}_{1} + {L}_{2}}{{L}_{1}} {p}_{1} \qquad ( 1 )$$

For example, the arrangement pitch p₂ is 5 μm. The thickness of the X-ray absorbing sections 21a in the Z direction is in the order of 100 μm, for example, in consideration of vignetting of the cone beam of X-rays emitted from the X-ray source 11.

The first and second grids 21 and 22 project the X-rays having passed through the X-ray transparent sections 21a and 22a in a geometrical-optics manner. To be more specific, since the widths of the X-ray transparent sections 21b and 22b in the X direction are set enough larger than the effective wavelength of the X-rays emitted from the X-ray source 11, the first and second grids 21 and 22 straight pass almost all X-rays without diffraction. When tungsten is used as the rotating anode of the X-ray tube in the X-ray source 11 and tube voltage is 50 kV, for example, the effective wavelength of the X-rays is approximately 0.4 Å. In this case, the allowable width of the X-ray transparent sections 21b and 22b is in the order of 1 to 10 μm.

The length L₂ is limited to the Talbot distance in the case of a Talbot interferometer. In this embodiment, however, the length L₂ can be established irrespective of the Talbot distance, because the first and second grids 21 and 22 project the X-rays in a geometrical-optics manner.

The imaging unit 12 according to this embodiment does not compose the Talbot interferometer, as described above. However, with the assumption that the first grid 21 diffracts the X-rays and brings about the Talbot interference, the Talbot distance Zₘ is represented by the following expression (2), using the arrangement pitches p₁ and p₂, the wavelength λ of the X-rays, and a positive integer m:

$${Z}_{m} = m \frac{{p}_{1} {p}_{2}}{λ} \qquad ( 2 )$$

The expression (2) represents the Talbot distance in a case where the X-ray source 11 emits the cone beam of X-rays, and is known by Timm Weitkamp et al. (Proc. of SPIE, Vol. 6318, 2006, page 63180S).

In this embodiment, the length L₂ can be set irrespective of the Talbot distance Zₘ. Therefore, the length L₂ is set shorter than the minimum Talbot distance Z₁ defined at m=1, for the purpose of slimming the imaging unit 12.

In the imaging unit 12 having the above structure, the first grid 21 produces the G1 image. Then, the second grid 22 applies the intensity modulation to the G1 image by superimposition, and produces a second periodic pattern image (hereinafter called G2 image). The X-ray image detector 20 captures the G2 image. If a slight difference occurs between a pattern period of the G1 image formed in the position of the second grid 22 and a grid period (arrangement pitch p₂) of the second grid 22 due to a positioning error or the like, a moiré fringe emerges in the G2 image.

When the sample H is disposed between the X-ray source 11 and the first grid 21, the G2 image is modulated by the sample H. This modulation amount depends on angles of the deflected X-rays due to the refraction by the sample H.

Next, the principles of a fringe scanning method will be described. FIG. 3 shows an example of a route of the X-ray that is refracted according to phase shift distribution Φ(x) of the sample H with respect to the X direction. A reference numeral X1 indicates a route of the X-ray that travels in a straight line in the absence of the sample H. The X-ray traveling in this route X1 passes through the first and second grids 21 and 22, and is incident upon the X-ray image detector 20. A reference numeral X2, on the other hand, indicates a route of the X-ray that is refracted by the sample H in the presence of the sample H. The X-ray traveling in this route X2 passes through the first grid 21, and then is absorbed by the X-ray absorbing section 22a of the second grid 22.

The phase shift distribution Φ(x) of the sample H is represented by the following expression (3):

$$Φ ( x ) = \frac{2 π}{λ} \int [ 1 - n ( x , z ) ] d z \qquad ( 3 )$$

Wherein, n(x, z) represents refractive index distribution of the sample H. For the sake of simplicity, a Y coordinate is omitted in the expression (3).

The G1 image formed by the first grid 21 in the position of the second grid 22 is displaced in the X direction by an amount corresponding to a refraction angle φ due to the refraction of the X-ray in passing through the sample H. This displacement Δx is approximately represented by the following expression (4), on condition that the refraction angle φ is sufficiently small:

Δx≈L₂φ (4)

The refraction angle φ is represented by the following expression (5), using the wavelength λ, of the X-ray and the phase shift distribution Φ(x):

$$φ = \frac{λ}{2 π} \frac{\partial Φ ( x )}{\partial x} \qquad ( 5 )$$

As is obvious from the above expressions, the displacement Δx is related to the phase shift distribution Φ(x) of the sample H. Furthermore, the displacement Δx and the refraction angle φ are related to a phase shift amount ψ of the intensity modulation signal of each pixel 30 by the sample H, as is represented by the following expression (6). The intensity modulation signal is a waveform signal that represents change of a pixel value with respect to the scan position of the second grid 22 relative to the first grid 21, though detail will be described later.

$$ψ = \frac{2 π}{{p}_{2}} Δ x = \frac{2 π}{{p}_{2}} {L}_{2} φ \qquad ( 6 )$$

Thus, determination of the phase shift amount ψ of the intensity modulation signal of each pixel 30 leads to obtainment of the phase shift distribution Φ(x) using the expressions (5) and (6). The two-dimensional distribution of the phase shift amount ψ corresponds to the above differential phase image.

In the fringe scanning method, while one of the first and second grids 21 and 22 is translationally moved (scanned) relative to the other in the X direction, the G2 image is captured at each of plural predetermined scan positions. In this embodiment, the first grid 21 is fixed, while the second grid 22 is moved in the X direction by the scan mechanism 23. The moiré fringes occurring in the G2 image vary with the movement of the second grid 22. When the movement distance reaches the grid period (arrangement pitch p₂) of the second grid 22, the moiré fringes return to the original positions.

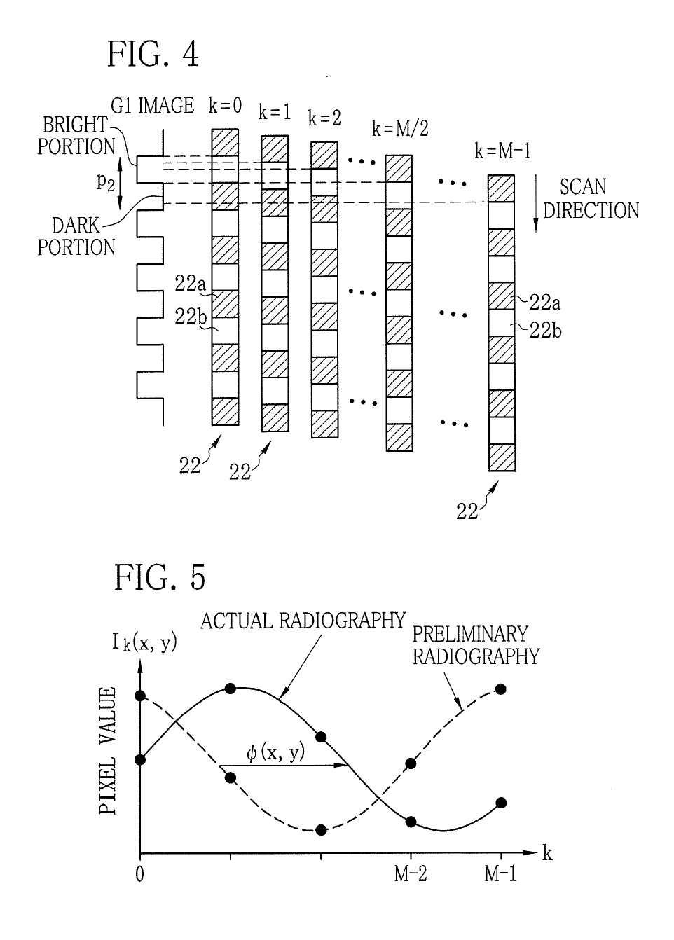

FIG. 4 schematically shows a state of moving the second grid 22 by a scan pitch of p₂/M, in which the arrangement pitch p₂ is divided by M (integer of 2 or more). The scan mechanism 23 stepwise moves the second grid 22 to each of an M frames of scan positions represented by k=0, 1, 2, . . . , M−1.

In the position of k=0, the X-rays that have not been refracted by the sample H mainly pass through the second grid 22. While the second grid 22 is successively moved to k=1, 2, . . . , an X-ray component having not been refracted by the sample H is decreased, and an X-ray component having been refracted by the sample H is increased. Especially, in the position of k=M/2, the X-rays passed through the second grid 22 substantially consist of the refracted X-ray component. After the position of M/2, on the contrary, the refracted X-ray component is decreased and the non-refracted X-ray component is increased in the X-rays detected through the second grid 22.

Since the X-ray image detector 20 captures the G2 image in each of the scan positions of k=0, 1, 2, . . . , M−1, an M number of image data is recorded to the memory 13. An M number of pixel values obtained on a pixel-by-pixel basis compose the intensity modulation signal. The obtainment of the M number of image data by the fringe scanning is carried out in each of actual radiography performed in the presence of the sample H and preliminary radiography performed in the absence of the sample H, and the obtained image data is recorded to the memory 13.

To be more specific, as shown in FIG. 5, the M number of pixel values obtained in each pixel 30 periodically fluctuate relative to the scan position k. In FIG. 5, a broken line indicates the intensity modulation signal obtained in the preliminary radiography. A solid line, on the other hand, indicates the intensity modulation signal the phase of which is shifted by the phase shift amount ψ(x, y) due to the presence of the sample H in the actual radiography. Here, “x” and “y” represent the x and y coordinates of the pixel 30, and calculating the phase shift amount ψ(x, y) of each pixel 30 allows obtainment of the differential phase image.

Next, a method for calculating the phase shift amount ψ(x) will be described. The intensity modulation signal that indicates the fluctuation of the pixel value Iₖ(x, y) relative to the scan position k is generally represented by the following expression (7):

$${I}_{k} ( x , y ) = {A}_{0} + {\sum }_{n > 0} {A}_{n} exp [ n i \{ ψ ( x , y ) + 2 π \frac{k}{M} \} ] \qquad ( 7 )$$

Wherein, “A₀” represents a value corresponds to the intensity of the incident X-rays, and “Aₙ” represents a value corresponding to the amplitude of the intensity modulation signal. “n” represents a positive integer, and “i” is an imaginary unit.

The following expression (8) holds, when the scan pitch is made constant by equal division of the arrangement pitch p₂. Using the expression (8), the phase shift amount ψ(x) is transformed into the following expression (9).

$$\begin{matrix}{\sum }_{k = 0}^{M - 1} exp ( - 2 π i \frac{k}{M} ) = 0 & ( 8 ) \\ ψ ( x , y ) = arg [ {\sum }_{k = 0}^{M - 1} {I}_{k} ( x , y ) exp ( - 2 π i \frac{k}{M} ) ] & ( 9 )\end{matrix}$$

The two-dimensional distribution of the phase shift amount ψ(x, y) corresponds to the differential phase image. The phase shift amount ψ(x, y) is also represented by the following expression (10) using trigonometric functions:

$$ψ ( x , y ) = - {tan}^{- 1} \frac{{\sum }_{k = 0}^{M - 1} {I}_{k} ( x , y ) sin ( - 2 π \frac{k}{M} )}{{\sum }_{k = 0}^{M - 1} {I}_{k} ( x , y ) cos ( - 2 π \frac{k}{M} )} \qquad ( 10 )$$

When the moiré fringes occur in the G2 image, moiré fringes inevitably occur in the differential phase image too. The differential phase image is calculated using the above expression (10), which takes on values from −π/2 to π2. The moiré fringes occur by the so-called phase jump. Therefore, a moiré period of the differential phase image is half of a moiré period of the G2 image detected by the X-ray image detector 20.

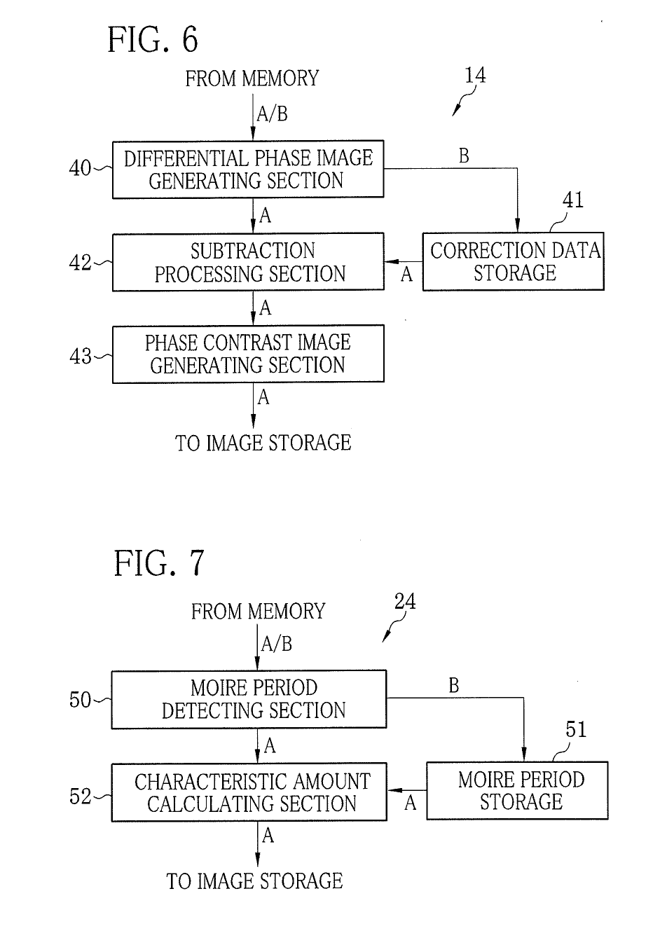

Next, the structure of the image processor 14 and the moiré fringe difference detector 24 will be described. In FIG. 6, the image processor 14 is provided with a differential phase image generating section 40, correction data storage 41, a subtraction processing section 42, and a phase contrast image generating section 43. An arrow with a sign “A” indicates a route of various types of data flowing through the components operated during the actual radiography. An arrow with a sign “B” indicates a route of various types of data flowing through the components operated during the preliminary radiography. An arrow with a sign “A/B” indicates a route of various types of data flowing through the components operated during both the actual radiography and the preliminary radiography.

To the differential phase image generating section 40, the M number of image data that is obtained by the fringe scanning during the actual radiography and the preliminary radiography and stored on the memory 13 is read out. The differential phase image generating section 40 generates the differential phase image from the M number of image data by the method described above. A first differential phase image produced by the differential phase image generating section 40 during the actual radiography is inputted to the subtraction processing section 42. On the other hand, a second differential phase image produced by the differential phase image generating section 40 during the preliminary radiography is inputted to the correction data storage 41 as correction data. The correction data storage 41 stores the inputted second differential phase image, and inputs the second differential phase image to the subtraction processing section 42 in performing the actual radiography.

The subtraction processing section 42 carries out correction processing, by which the second differential phase image is subtracted from the first differential phase image inputted during the actual radiography. Then, a corrected differential phase image is inputted to the phase contrast image generating section 43. The phase contrast image generating section 43 integrates the corrected differential phase image in the X direction to produce the phase contrast image, and the phase contrast image is inputted to the image storage 15.

As shown in FIG. 7, the moiré fringe difference detector 24 is provided with a moiré period detecting section 50, moiré period storage 51, and a characteristic amount calculating section 52. In FIG. 7, signs given to arrows indicate the same meaning as above.

To the moiré period detecting section 50, a single frame of image data (for example, image data obtained in the scan position of k=0) out of the M frames of image data, which is obtained by the fringe scanning during the actual radiography and the preliminary radiography, is inputted from the memory 13. The moiré period detecting section 50 performs discrete Fourier transform on the image data consisting of the pixel values Iₖ (x, y) based on the following expression (11), to obtain a two-dimensional Fourier spectrum F (u, v). Then, the moiré period detecting section 50 calculates the moiré period from the two-dimensional Fourier spectrum F(u, v).

$$F ( u , v ) = {\sum }_{x = 1}^{{N}_{x}} {\sum }_{y = 1}^{{N}_{y}} exp [ - 2 πi ( \frac{ux}{{N}_{x}} + \frac{uy}{{N}_{y}} ) ] \qquad ( 11 )$$

Wherein Nₓ represents the number of the pixels composing the image data in the X direction, and N_{y} represents the number of the pixels in the Y direction.

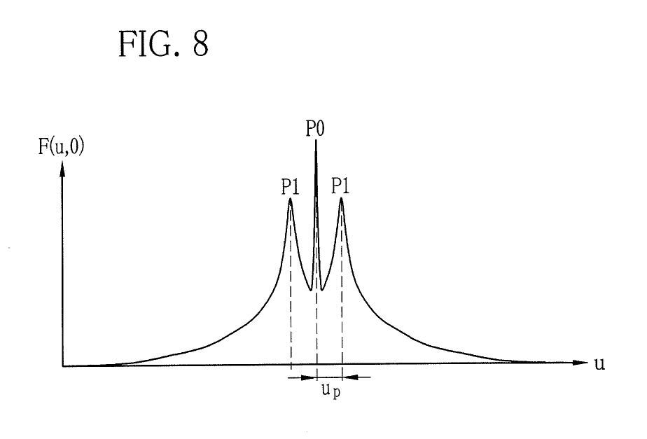

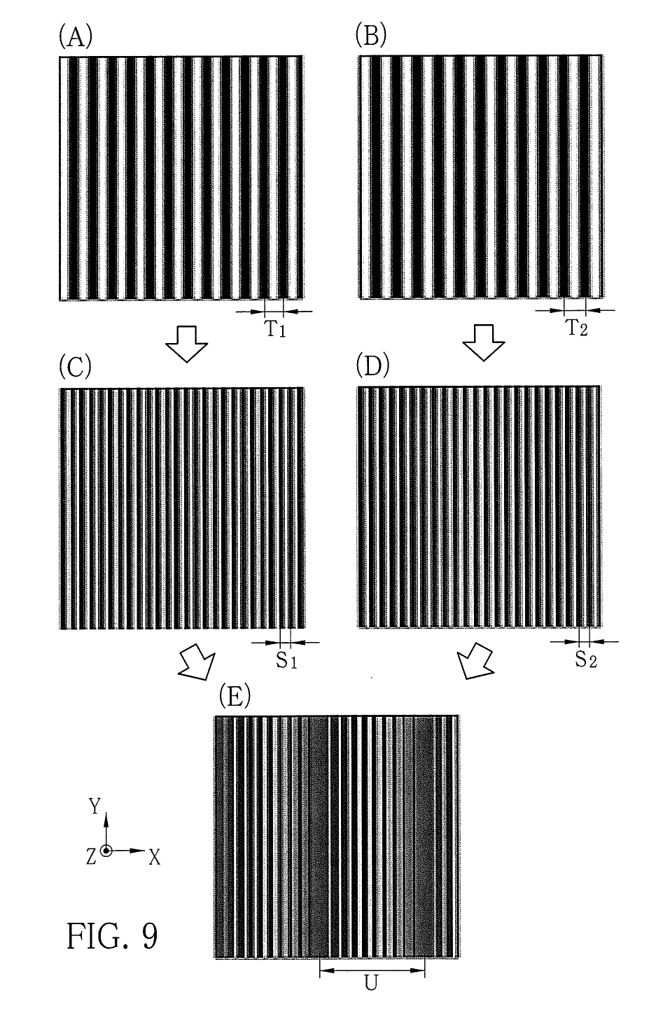

More specifically, as shown in FIG. 8, the moiré period detecting section 50 elicits from the two-dimensional Fourier spectrum F(u, v) a profile passing through the zero-order peak P0 along a u direction, and calculates a distance uₚ from the zero-order peak P0 to the isolated first-order peak P1. Then, the moiré period detecting section 50 calculates the reciprocal of the distance uₚ to obtain the moiré period. Note that, the above discrete Fourier transform is performed using a well-known fast Fourier transform algorithm.

A first moiré period T₁ calculated in the actual radiography by the moiré period detecting section 50 is inputted to the characteristic amount calculating section 52. On the other hand, a second moiré period T₂ calculated in the preliminary radiography by the moiré period detecting section 50 is inputted to the moiré period storage 51. The moiré period storage 51 stores the inputted second moiré period T₂, and outputs the second moiré period T₂ to the characteristic amount calculating section 52 during the actual radiography.

The characteristic amount calculating section 52 calculates the characteristic amount of an artifact, which occurs in the corrected differential phase image produced by the subtraction processing section 42 of the image processor 14, based on the inputted first and second moiré periods T₁ and T₂.

Referring to FIG. 9, the characteristic amount of the artifact occurring in the corrected differential phase image will be described. FIG. 9(A) shows an example of first image data inputted to the moiré period detecting section 50 in the actual radiography. FIG. 9(B) shows an example of second image data inputted to the moiré period detecting section 50 in the preliminary radiography. The first moiré period T₁ is smaller than the second moiré period T₂ by approximately 10%. Note that, FIG. 9 does not include change of the moiré fringes by the sample H, for the simplicity of explanation about the change of the moiré fringes between the preliminary radiography and the actual radiography.

FIG. 9(C) shows the first differential phase image produced in the actual radiography from the M frames of image data including the first image data shown in (A). FIG. 9(D) shows the second differential phase image produced in the preliminary radiography from the M frames of image data including the second image data shown in (B). Moiré periods S₁ and S₂ occurring in the first and second differential phase images are half of the first and second moiré period T₁ and T₂, respectively, as described above.

FIG. 9(E) shows the corrected differential phase image produced by the subtraction of the second differential phase image from the first differential phase image. The corrected differential phase image contains a component of moiré fringes that have not been compensated for because of the difference between the moiré periods S₁ and S₂ of the first and second differential phase images as the stripe-patterned artifact. The period U of the artifact in the X direction is represented by the following expression (12):

$$U = \frac{{S}_{1} {S}_{2}}{\vert {S}_{1} - {S}_{2} \vert} \qquad ( 12 )$$

In addition, this period U is represented by the following expression (13) using the first and second moiré periods T₁ and T₂.

$$U = \frac{{T}_{1} {T}_{2}}{2 \vert {T}_{1} - {T}_{2} \vert} \qquad ( 13 )$$

The characteristic amount calculating section 52 calculates the period U of the artifact based on the expression (13), and provides the period U to the system controller 18. In terms of the fact that the artifact is negligible if the period U is larger than a view size W of the X-ray image detector 20 in the X direction, the system controller 18 compares the period U with the view size W. Note that, as shown in FIG. 2, the view size W refers to the length of the imaging plane 31 in the X direction.

When the period U is smaller than the view size W, the system controller 18 stops the operation of the image processor 14, and displays a message to suggest the re-execution of the preliminary radiography on the monitor (notification section) 17b, instead of displaying the phase contrast image on the monitor 17b.

Next, the operation of the X-ray imaging system 10 having above structure will be described. First, the execution command of the preliminary radiography is inputted from the key panel 17a in the absence of the sample H, the scan mechanism 23 translationally moves the second grid 22 at the predetermined scan pitch (p₂/M). In every scan position k, the X-ray source 11 emits the X-rays, and the X-ray image detector 20 detects the G2 image. As a result, M frames of image data is produced and written to the memory 13.

After that, the image processor 14 reads out the M frames of image data from the memory 13. In the image processor 14, the differential phase image generating section 40 produces the second differential phase image. The second differential phase image is written to the correction data storage 41 and the correction data. At the same time, the moiré fringe difference detector 24 reads out one frame of image data out of the M frames of image data from the memory 13. In the moiré fringe difference detector 24, the moiré period detecting section 50 detects the second moiré period T₂, and writes the second moiré period T₂ to the moiré period storage 51. The operation of the preliminary radiography is now completed.

Subsequently, when the execution command of the actual radiography is inputted from the key panel 17a in the presence of the sample H, the second grid 22 is translationally moved, as in the case of the preliminary radiography. In every scan position k, the X-rays are emitted, and the G2 image is detected. As a result, M frames of image data is written to the memory 13.

After that, the image processor 14 reads out the M frames of image data from the memory 13. In the image processor 14, the differential phase image generating section 40 produces the first differential phase image. At the same time, the moiré fringe difference detector 24 reads out one frame of image data out of the M frames of image data from the memory 13. In the moiré fringe difference detector 24, the moiré period detecting section 50 detects the first moiré period T₁. The first moiré period T₁ is inputted to the characteristic amount calculating section 52, while the second moiré period T₁ stored in the moiré period storage 51 is inputted to the characteristic amount calculating section 52.

The characteristic amount calculating section 52 calculates the period U of the artifact based on the first and second moiré periods T₁ and T₂. This period U is provided to the system controller 18. The system controller 18 compares the period U with the view size W. When the period U is smaller than the view size W, the operation of the image processor 14 is stopped, and the message to suggest the re-execution of the preliminary radiography saying “please re-execute preliminary radiography” is displayed on the monitor 17b.

When the period U is larger than the view size W, the operation of the image processor 14 is continued. In the image processor 14, the first differential phase image is inputted to the subtraction processing section 42, while the second differential phase image stored in the correction data storage 41 is inputted to the subtraction processing section 42. The subtraction processing section 42 subtracts the second differential phase image from the first differential phase image, to produce the corrected differential phase image. This corrected differential phase image is inputted to the phase contrast image generating section 43. The phase contrast image generating section 43 applies an integration process to the corrected differential phase image to produce the phase contrast image. This phase contrast image is written to the image storage 15, and is displayed on the monitor 17b.

Note that, when the preliminary radiography is re-executed in response to the above message, the subtraction processing section 42 performs a subtraction process using the second differential phase image obtained in the re-executed preliminary radiography and the first differential phase image obtained in the prior actual radiography, and produces the corrected differential phase image. This corrected differential phase image is converted into the phase contrast image, as with above. The phase contrast image is written to the image storage 15, and is displayed on the monitor 17b.

As described above, according to this X-ray imaging system 10, when the difference in the moiré fringes is large between the image data obtained in the preliminary radiography and that in the actual radiography, the re-execution of the preliminary radiography is recommended. Therefore, it is possible to always reduce the occurrence of the artifact in the corrected differential phase image produced by the subtraction processing section 42.

In the above embodiment, the period of the moiré fringes of the image data is changed between the preliminary radiography and the actual radiography. However, the present invention is applicable to a case where the moiré fringes of the image data rotate between the preliminary radiography and the actual radiography, or a case where the period of the moiré fringes becomes uneven and the density of the moiré fringes is changed.

In the case of the rotation of the moiré fringes, the zero-order peak occurring in the two-dimensional Fourier spectrum F(u, v) of the image data deviates from an origin point (point of u=v=0). In this case, the moiré period in the X direction is detectable by obtaining the distance from the zero-order peak to the first-order peak in the u direction, as with above. In a case where the period of the moiré fringes becomes uneven, the distribution of the first-order peak spreads, but the moiré period (average value) in the X direction is detectable, as with above.

In the above embodiment, the moiré periods T₁ and T₂ are detected by applying the discrete Fourier transform to the image data obtained in the preliminary radiography and the actual radiography, respectively, and the period U of the artifact is calculated based on the moiré periods T₁ and T₂. Instead of this, the moiré period S₁ and S₂ may be detected by applying the discrete Fourier transform to the first and second differential phase images, respectively, and the period U of the artifact may be calculated based on the moiré periods S₁ and S₂.

In the above embodiment, the system controller 18 compares the period U of the artifact with the view size W. Instead of this, judgment may be performed based on a ratio between the period U and the view size W. For example, the judgment is performed with considering the fact that the artifact of the corrected differential phase image is modulated such that its phase is shifted by π during the period U, and a modulation amount ψ_{w} with the view size of W is represented by the following expression (14):

$${ψ}_{W} = π \frac{W}{U} \qquad ( 14 )$$

The smaller the modulation amount ψ_{w}, the less the artifact becomes conspicuous. Thus, the modulation amount ψ_{w} is compared with a predetermined threshold value ψ_{T}, and the re-execution of the preliminary radiography is suggested if the modulation amount ψ_{w} is larger than the threshold value ψ_{T}. This threshold value ψ_{T} may be determined with reference to a modulation amount by the sample H. Taking a case where the sample H is biological soft tissue, for example, the refraction angle φ of the X-rays by the sample H is in the order of 10⁻⁷ rad. The threshold value ψ_{T} may be the modulation amount of the phase corresponding to a value smaller than the refraction angle φ by the order of one digit. In this case, the threshold value ψ_{T} is represented by the following expression (15):

$${ψ}_{T} = \frac{2 π}{{p}_{2}} {L}_{2} \times {10}^{- 8} \qquad ( 15 )$$

In the above embodiment, the view size W refers to the length of the imaging plane 31 in the X direction, but may be the length of a predetermined area that captures an image of the sample H within the imaging plane 31.

In the above embodiment, the message to suggest the re-execution of the preliminary radiography is displayed on the monitor 17b by way of notification, but the notification may be performed in another way, such as sound or LED.

In the above embodiment, when the scan mechanism 23 translationally moves the second grid 22, an initial scan position is set at k=0. However, any position of k=0, 1, 2, . . . , M−1 is selectable as the initial scan position.

In the above embodiment, the phase contrast image is written to the image storage 15, and displayed on the monitor 17b. However, the corrected differential phase image may be written to the image storage 15 and displayed on the monitor 17b, instead of or in addition to the phase contrast image.

In the above embodiment, the subtraction processing section 42 uses the original first and second differential phase images in the subtraction process, but may use the first and second differential phase images each of which has been subjected to a phase unwrapping process. In the phase unwrapping process, the phase information wrapped in a range from −π/2 to π/2 is unwrapped into a continuous manner, in other words, the phase jump is removed in the first and second differential phase images. The phase unwrapping process may be applied to the corrected differential phase image produced by the subtraction processing section 42.

In the above embodiment, the two-dimensional distribution of the phase shift amount of the intensity modulation signal is defined as the differential phase image. The differential phase image, however, may be the two-dimensional distribution of any physical quantity such as the refraction angle (I), as long as the physical quantity is proportionate to a differential value of the phase shift distribution Φ(x, y).

In the above embodiment, the sample H is disposed between the X-ray source 11 and the first grid 21, but may be disposed between the first and second grids 21 and 22.

Although a source grid (multi-slit) is not disposed behind the X-ray source 11 in this embodiment, the source grid may be provided behind the X-ray source 11 to disperse an X-ray focus.

In the above embodiment, the first grid 21 geometric-optically projects the X-rays that have passed through its X-ray transparent sections 21b, but the present invention is not limited to this structure. The present invention may be applied to the structure in which the X-rays are diffracted by the X-ray transparent sections 21b, and produce the Talbot effect (refer to U.S. Pat. No. 7,180,979 corresponding to Japanese Patent No. 4445397). In this case, however, the distance L₂ between the first and second grids 21 and 22 has to be set at the above Talbot distance Zₘ. Also, in this case, a phase grid is available as the first grid 21 instead of the absorption grid. The first grid 21 forms its self image produced by the Talbot effect in the position of the second grid 22.

In the above embodiment, the first and second grids 21 and 22 are provided between the X-ray source 11 and the X-ray image detector 20, but the second grid 22 is not necessarily required. For example, using an X-ray image detector disclosed in U.S. Pat. No. 7,746,981 corresponding to Japanese Patent Laid-Open Publication No. 2009-133823 instead of the X-ray image detector 20 eliminates the need for providing the second grid 22. In this X-ray image detector, being of a direct conversion type, each pixel has a conversion layer for converting the X-rays into electric charge and a charge collection electrode for collecting the electric charge converted by the conversion layer. The charge collection electrode of each pixel is composed of plural linear electrode groups arranged out of phase with one another. Each linear electrode group includes linear electrodes, which are arranged at a constant period and electrically connected to one another.

In the above embodiment, the differential phase image is obtained by the fringe scanning method, but the differential phase image may be obtained by a Fourier transform method disclosed in International Publication No. WO 2010/050483. In the Fourier transform method, the image data containing the moiré fringes is subjected to Fourier transform to obtain a Fourier spectrum. A spectrum corresponding to a carrier frequency is separated from the Fourier spectrum, and the spectrum is subjected to inverse Fourier transform to obtain the differential phase image. This method eliminates the need for providing the scan mechanism 23.

The present invention is applicable to various types of radiation imaging systems for medical diagnosis, industrial use, nondestructive inspection, and the like. As the radiation, gamma rays or the like are available other than the X-rays.

Although the present invention has been fully described by the way of the preferred embodiment thereof with reference to the accompanying drawings, various changes and modifications will be apparent to those having skill in this field. Therefore, unless otherwise these changes and modifications depart from the scope of the present invention, they should be construed as included therein.

What is claimed is:

1. A radiation imaging system comprising:
a radiation image detector for capturing radiation emitted from a radiation source and producing image data;
at least one grid disposed between said radiation source and said radiation image detector;
a differential phase image generating section for generating a differential phase image based on said image data produced by said radiation image detector;
a subtraction processing section for subtracting a second differential phase image from a first differential phase image to produce a corrected differential phase image, said first differential phase image being generated by said differential phase image generating section in actual radiography performed in a presence of a sample between said radiation source and said radiation image detector, said second differential phase image being generated by said differential phase image generating section in preliminary radiography performed in an absence of said sample;
a moiré fringe difference detector for detecting a change in moiré fringes occurring in said first and second differential phase images between said actual radiography and said preliminary radiography and calculating a characteristic amount corresponding to said change; and
a judging section for judging based on said characteristic amount whether or not re-execution of said preliminary radiography is required.

2. The radiation imaging system according to claim 1, wherein said moiré fringe difference detector calculates as said characteristic amount a period of a stripe-patterned artifact occurring in said corrected differential phase image.

3. The radiation imaging system according to claim 2, wherein said judging section compares said period of said artifact with a view size of said radiation image detector, and judges that said re-execution of said preliminary radiography is required when said period is smaller than said view size.

4. The radiation imaging system according to claim 2, wherein said judging section compares a ratio between said period of said artifact and a view size of said radiation image detector with a predetermined threshold value in order to judge whether or not said re-execution of said preliminary radiography is required.

5. The radiation imaging system according to claim 1, wherein when said re-execution of said preliminary radiography is carried out, said subtraction processing section subtracts a new second differential phase image newly produced in said re-execution by said differential phase image generating section from said first differential phase image in order to produce a new corrected differential phase image.

6. The radiation imaging system according to claim 1, further comprising:
a notification section for sending out a message to suggest said re-execution of said preliminary radiography, when said judging section judges that said re-execution of said preliminary radiography is required.

7. The radiation imaging system according to claim 1, further comprising:
a phase contrast image generating section for generating a phase contrast image from said corrected differential phase image through an integration process.

8. The radiation imaging system according to claim 1, wherein said grid refers to first and second grids disposed oppositely to each other between said radiation source and said radiation image detector such that grid directions of said first and second grids coincide.

9. The radiation imaging system according to claim 8, further comprising:
a scan mechanism for varying a position of said second grid relative to a position of said first grid to sequentially set said first and second grids at plural scan positions;
wherein said differential phase image generating section calculates a phase shift amount of an intensity modulation signal, which represents variation of a pixel value composing said image data relative to said scan positions, to generate said differential phase image.

10. The radiation imaging system according to claim 8, wherein said first grid is an absorption grid, and projects said radiation incident from said radiation source to said second grid in a geometrical-optics manner.

11. The radiation imaging system according to claim 8, wherein said first grid is a phase grid, and forms a self image in a position of said second grid by causing a Talbot effect in said radiation incident from said radiation source.

12. A control method of a radiation imaging system, said radiation imaging system including a radiation image detector for capturing radiation emitted from a radiation source and producing image data, at least one grid disposed between said radiation source and said radiation image detector, a differential phase image generating section for generating a differential phase image based on said image data produced by said radiation image detector, and a subtraction processing section for subtracting a second differential phase image from a first differential phase image to produce a corrected differential phase image, said first differential phase image being generated by said differential phase image generating section in actual radiography performed in a presence of a sample between said radiation source and said radiation image detector, and said second differential phase image being generated by said differential phase image generating section in preliminary radiography performed in an absence of said sample, said control method comprising the steps of:
detecting a change in moiré fringes occurring in said first and second differential phase images between said actual radiography and said preliminary radiography;
calculating a characteristic amount corresponding to said change; and
judging based on said characteristic amount whether or not re-execution of said preliminary radiography is required.
